(19) United States
(12) Patent Application Publication
(10) Pub. No.: US 2022/0219822 A1
(43) Pub. Date: Jul. 14, 2022

(54) System For Automatically Adapting Operating Parameters Of An On-Board Kitchen Facility

(71) Applicant: Airbus Operations GmbH, Hamburg (DE)

(72) Inventors: Matthias Reiss, Hamburg (DE); Michael Bauer, Hamburg (DE); Rafael Mortensen Ernits, Bremen (DE); Michael Freitag, Bremen (DE)

(73) Assignee: Airbus Operations GmbH, Hamburg (DE)

(21) Appl. No.: 17/612,462

(22) PCT Filed: May 20, 2020
(86) PCT No.: PCT/EP2020/064038

§ 371 Date: Nov. 18, 2021

(30) Foreign Application Priority Data
May 23, 2019 (DE) 10 2019 207 581.9

(51) Int. Cl. B64D 11/00; H05B 6/64; A47J 36/32

(52) U.S. Cl. CPC B64D 11/0007; G06K 7/1413; A47J 36/32; H05B 6/6441

(57) ABSTRACT

A system for automatically adapting operating parameters of a galley device on the basis of provided supply items for on-board catering for a vehicle, in particular an aircraft, includes a galley device that has an identification device that is designed to identify a supply item; and a control device for controlling the galley device, wherein the control device is designed to provide operating parameters for the identified supply item and to operate the galley device in accordance with the operating parameters.

The present invention relates to a system for automatically adapting operating parameters of a galley device on the basis of provided supply items for on-board catering for a vehicle, in particular an aircraft.

Although it is able to be used in a wide variety of applications, the present invention and the problem on which it is based are explained in more detail with reference to passenger aircraft. The described methods and devices may however likewise be used in different vehicles and in all sectors of the transport industry, for example for road vehicles, for rail vehicles, for aircraft or for watercraft.

Galleys currently provided on board modern passenger aircraft usually comprise spaces or slide-in compartments into which containers and/or wheeled containers (also referred to as trolleys or galley carts) are able to be inserted, these being loaded with supply items or service products, such as for example food and/or beverages, to be supplied to passengers on board the aircraft. By way of example, the supply items may be provided in the form of trays, which are each pre-packed with several products, for example ready meals, beverages, etc. To identify the contents of the trolleys or containers, these are conventionally provided with adhesive labels that the catering company applies when loading. Lists are additionally created, from which the cabin crew are able to derive an inventory of the available service products and their storage position in the aircraft galley.

Modern galleys typically contain electrical galley devices such as ovens or microwaves or the like for the preparation of food and beverages. It is usually up to the flight crew to select and set the appropriate operating parameters of the respective galley device, such as for example preparation temperature or preparation time, for each dish. This may also be performed for example by selecting a predefined operating strategy or a specified operating mode. Such manual setting of the galley device is sometimes considered to be laborious, time-consuming and susceptible to mistakes. If for example unusual or special meals are supposed to be prepared, the flight crew first have to find out which operating settings the meal specifically needs for optimum preparation.

Document DE 10 2009 058 327 A1 discloses a system for storage in an aircraft galley, in which receptacle devices such as boxes, compartments or trolleys or the like are provided with transponders that emit identification signals characteristic of their content, which signals in turn are read by a transceiver of the galley in order thereby to determine the inventory of the galley. This is intended to improve the overview of the inventory of the galley.

Against this background, the present invention is based on the object of finding improved solutions for the operation of galley devices, in which the operation is adapted to the respective supply item in an optimum manner.

According to the invention, this object is achieved by a system having the features of patent claim 1 and by an aircraft having the features of patent claim 14.

Accordingly, what is provided is a system for automatically adapting operating parameters of a galley device on the basis of provided supply items for on-board catering for a vehicle. The system comprises a galley device that has an identification device that is designed to identify a supply item; and a control device for controlling the galley device, wherein the control device is designed to provide operating parameters for the identified supply item and to operate the galley device in accordance with the operating parameters.

What is also provided is an aircraft having a system according to the invention.

One idea on which the present invention is based is that of automating the selection of the operating parameters by first identifying the supply items using an identification device, for example a camera, a sensor, a barcode reader, an RFID scanner, etc., and automatically implementing an optimum setting of the operating parameters based thereon. An optimum operating mode of the respective galley device is thus implemented automatically for each supply item. This unburdens the flight crew to a considerable extent. At the same time, it is ensured for example that food or the like is prepared satisfactorily. The respective galley device may furthermore be operated with optimized energy consumption, such that power consumption is additionally reduced and energy management is improved. The corresponding data may furthermore be used to monitor, inspect and analyze food preparation.

The term “supply item” used in the present case comprises, on the one hand, individual packaged or unpackaged foodstuffs such as food and beverages. On the other hand, the term “supply item” within the meaning of the invention however likewise includes products that consist of several components or combinations of individual products, such as for example ready meals (with one or more components), pre-packed trays, etc.

Advantageous embodiments and developments will emerge from the further dependent claims and from the description with reference to the figures.

According to one development, the galley device may comprise an oven, a microwave and/or a cooling device. By way of example, the preparation in an oven or a microwave may be adapted to the respective supply item, for example with regard to preparation time and/or preparation temperature of a ready meal. Storage in a refrigerator, a cooling compartment or a similar cooling device may likewise be adapted to the respective supply item in an optimum manner. By way of example, the storage temperature, air humidity, air circulation or the like may be set specifically for each supply item. Other possible uses are for example cooled service units, that is to say wheeled containers, trolleys, food carts, containers or the like. In one specific example, a slide-in compartment or compartment of a galley for accommodating a service unit may be cooled. In this context, it would be conceivable to prove, for certain supply items, for example pre-packed trays and/or individual meals/drinks, that the cold chain has been complied with on board the vehicle. For this purpose, the corresponding data could be stored in the system, for example in a data memory.

According to one development, the operating parameters may be selected from the group comprising preparation temperature, storage temperature, preparation time, storage time, humidity, air pressure and air circulation. It goes without saying, however, that a person skilled in the art may also use other variables or parameters, which are advantageous or relevant for the respective application case, as operating parameters within the meaning of the invention. By way of example, a use-by date of the supply item may be read during identification and may be stored on the supply item, for example in the form of a barcode or some other identifier.

According to one development, the control device may be designed to provide an operating strategy for the identified supply item that specifies a change in the operating parameters as a function of time, and to operate the galley device in accordance with the operating strategy. This means that it is possible to permanently set not just certain operating parameters, for example an oven temperature. In addition, more or less complex operating modes and/or operating strategies may be implemented or set for the respective supply item. By way of example, individual heating zones of an oven and/or a range may be activated or deactivated in a time-dependent manner depending on preparation recommendations for the respective supply item, for example a ready meal.

According to one development, the identification device may be designed to identify the supply item on the basis of an identifier attached thereto. By way of example, optoelectronically legible writing such as barcodes or the like may be attached to the outside of the supply items and be able to be recognized by the identification device. The identification device may accordingly be designed for example as a barcode scanner or the like. Barcodes within the meaning of the invention in this case comprise both one-dimensional or linear barcodes and two-dimensional designs or matrix codes, for example QR codes, etc.

According to one development, the identification device may have a barcode reader. The identification device may thus be designed as a data acquisition unit that is able to read and forward various barcodes or the like. The barcode reader may be configured for example as a CCD scanner, laser scanner or the like.

Barcode readers within the meaning of the invention also however likewise comprise camera scanners or imagers, that is to say units that capture a barcode using an in particular optical camera and then process the recorded image through digital image processing in order to digitally capture the barcode.

According to one development, the identification device may be designed to identify the supply item using object recognition. As an alternative or in addition to identifier recognition, the identification device may thus also be designed for general object recognition in order to recognize individual products such as ready meals or beverages. By way of example, it is thus possible to identify products that are located on a pre-packed tray.

According to one development, the identification device may have a camera. By way of example, the identification device may have an optical camera by way of which shapes, colors, etc. of objects and/or surfaces are captured and a supply item is identified on the basis thereof.

According to one development, the identification device may be designed to identify the supply item in the region of a door and/or an access opening of the galley device. The supply item may thus be identified during or shortly before insertion into the galley device. By way of example, a barcode reader and/or a camera may be installed in the region of a door of an oven, a microwave or a refrigerator in order to identify the supply item before the start of the preparation process or before storage and to define the preparation strategy or the storage strategy, including operating parameters, on the basis thereof.

According to one development, the identification device may be designed to identify the supply item in an interior of the galley device. As an alternative or in addition to identification in the region of a door or an access opening, the identification device may thus also recognize the supply item within the galley device. By way of example, a camera and/or one or more sensors within an oven, a microwave and/or a refrigerator may be designed to identify a supply item inserted into the respective unit.

According to one development, the system may furthermore comprise a data memory connected in terms of communication to the control device. The data memory may be designed to store the operating parameters for specified supply items. The data memory may thus store specifications for different supply items, which specify how the respective supply items should be prepared and/or should be stored. Different operating parameters, operating strategies and/or operating modes may be stored for each type of supply item. The data memory may in this case be provided locally in the galley. As an alternative or in addition, the data memory may also be queried via a data connection. In this case, the data memory may also be located outside the vehicle; by way of example, it may be provided by an airline and/or a catering service provider. The data memory may furthermore be used to store data relating to the supply items. By way of example, inventory management data for a galley may be managed and analyzed, for example in order to track the storage and/or preparation of the supply items. This may for example be used to trace a cold chain on board a vehicle and check it for compliance.

According to one development, the control device may be connected in terms of communication to a cabin management system and/or a communication system of the vehicle. By way of example, the control device may be connected to a controller area network (CAN) of a cabin management system or the like, via which a connection to external catering service providers, airlines, etc. may also be possible.

According to one development, the system may furthermore comprise a galley display. The galley display may be designed to display the operating parameters and/or information about the identified supply item. The galley display may additionally be designed to display operating strategies or operating modes. In specific examples, the galley display may be designed as an electronic optical display or a display with or without operating functions, for example as an LED, OLED, TFT or LCD screen or the like with or without background lighting and/or as a touch screen, etc. which, in addition to outputting information, also allows input via a screen serving as a touch panel. The galley display may be used to monitor and/or control the galley. To this end, the galley display may be coupled to the control device.

The above embodiments and developments may be combined with one another as desired where expedient. Further possible embodiments, developments and implementations of the invention also encompass combinations, which are not explicitly mentioned, of features of the invention described above or below with regard to the exemplary embodiments. A person skilled in the art here will in particular also add individual aspects as improvements or additions to the respective basic form of the present invention.

The present invention will be discussed in more detail below on the basis of the exemplary embodiments shown in the schematic figures. In the figures:

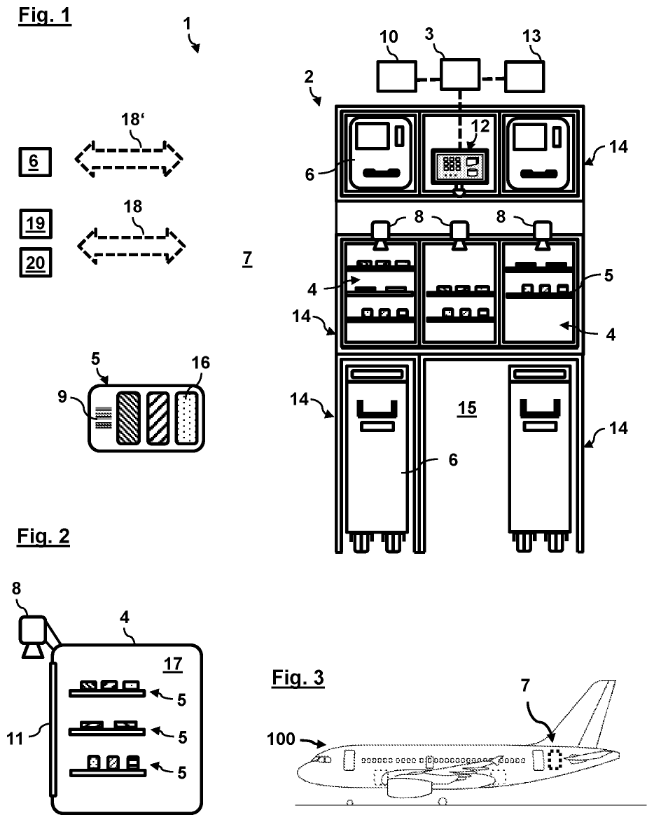

FIG. 1 shows a schematic view of a system for automatically adapting operating parameters of a galley device on the basis of provided supply items for on-board catering for a vehicle according to one embodiment of the invention;

FIG. 2 shows a schematic side-on sectional view of a galley device from the system from FIG. 1; and

FIG. 3 shows a schematic view of an aircraft having the system from FIG. 1.

The appended figures are intended to provide improved understanding of the embodiments of the invention. They illustrate embodiments and serve, in conjunction with the description, for the explanation of principles and concepts of the invention. Other embodiments, and many of the stated advantages, will emerge with regard to the drawings. The elements of the drawings are not necessarily shown true to scale relative to one another.

In the figures of the drawing, elements, features and components that are identical, functionally identical and of identical action are denoted in each case by the same reference signs unless stated otherwise.

FIG. 1 shows a schematic view of a system 1 for automatically adapting operating parameters of a galley device 4 on the basis of provided supply items 5 for on-board catering for a vehicle according to one embodiment of the invention. The system 1 is provided in a vehicle cabin 7 of an aircraft 100, in particular a passenger aircraft, as shown by way of example in FIG. 3. The system 1 comprises a galley 2, which is subdivided, purely by way of example, into several galley monuments 14 in FIG. 1. Each of these galley monuments 14 has one or more slide-in compartments 15 that are designed to receive one or more service units 6.

A service unit in this case denotes, on the one hand, service carts such as wheeled containers, that is to say trolleys, food carts or the like. The term “service unit” however furthermore likewise comprises general receptacle devices or transport devices for supply items and/or service products, such as for example containers, boxes (or “standard units”) or the like. Furthermore, a tray or a corresponding transport device may also constitute a service unit.

For instance, one of the galley monuments 14 (on the bottom left in the galley 2 in FIG. 1) has a slide-in compartment 15 for receiving a service unit 6, in this case a wheeled container. A slide-in compartment 15 for two wheeled containers is formed to the right thereof (on the bottom right in the galley in FIG. 1) in the galley monument 14, one of these two wheeled containers currently being in use. Above these two galley monuments 14 there is arranged a third galley monument 14, which comprises three galley devices 4 arranged next to one another, for example ovens, microwaves or cooling compartments or the like. Such a galley device 4 is shown by way of example in FIG. 2 in a side-on sectional view. On this galley monument 14 there is in turn placed another galley monument 14 that is able to receive standard units in the form of service units 6 in individual slide-in compartments 15, for example food containers. The slide-in compartments 15 may for example have standardized dimensions for receiving standardized containers, trolleys or the like.

The upper galley monument 14 comprises an integrated galley display 12. The galley display 12 may be for example a screen using OLED or LCD technology or the like, wherein the galley display 12 may be designed as a touch screen or touch display with touch-sensitive properties. The galley display 12 may furthermore be hinged on the galley monument 14 so as to be able to move. In this exemplary embodiment, the galley display 12 is used as a monitoring and/or operating device for the galley 2. To this end, the galley display 12 is connected to a control device 3 that is designed to control the galley 2 and the galley devices 4 contained therein. The control device 3 is in turn connected to a cabin management system 13, for example to a controller area network (CAN) or the like, on the one hand, and to a data memory 10, on the other hand. The control device 3 may in this case contain further components that are not illustrated, such as for example a microprocessor, etc.

The control device 3 may furthermore be designed to provide inventory management data for the galley 2, which may be displayed via the galley display 12. The inventory management data may, on the one hand, comprise an inventory register for each of the service units 6, that is to say for example including for wheeled containers that are in use. The inventory register may comprise a list of all of the supply items 5 or service products, for example food, drinks, etc., located in the respective service unit 6. On the other hand, the inventory management data may contain further data such as for example catering data, passenger data and/or cabin data or the like. Catering data may for example be provided by a caterer 20, such as a catering service provider and contain, inter alia, information about the on-board catering provided, that is to say which products are provided to what extent and in what form. Passenger data may for example be provided by an airline 19 and contain, inter alia, information about the passengers and which passengers have booked certain catering requests or options. The cabin data may for example be provided by the cabin management system 13 and contain, inter alia, information regarding the cabin configuration, for example a seating plan for the passengers, etc. In order to procure these data, the control device 3 may be connected to the individual providers or data sources in terms of communication, directly or indirectly through a data cable or wireless connection 18. In the exemplary configuration of FIG. 1, the control device 3 is connected to the cabin management system 13 via a data cable and may furthermore enter into contact with the airline 19 and the caterer 20, for example retrieve or request data from databases, via a wireless network 18 provided for this purpose.

The service units 6 may furthermore also be in communication with the galley 2 via a wireless network 18, via which the inventory management data are able to be kept up to date at all times. Such a wireless connection may be implemented for example via a wireless local area network, for example a WLAN or the like. Different designs are conceivable in this regard. By way of example, use may be made of a wireless network that is already present in a passenger cabin for other purposes. On the other hand, it is conceivable to provide a separate wireless network specifically for this purpose. This may in particular be a secure network able to be accessed only by people or units with appropriate security authentication, for example the on-board personnel of the vehicle and/or corresponding electronic devices that are intended/able to be operated only by the on-board personnel.

Each of the galley devices 4 is provided with an identification device 8 that is designed to identify a supply item 5 that is inserted into the galley device 4. To this end, the identification devices 8, in the example that is shown, are installed above a door 11 of the galley devices 4.

By way of example, the supply item 5, as shown by way of example at the bottom left in FIG. 1, may be a pre-packed meal tray containing several prepared ready meals 16 or dishes, for example a main course and two side dishes. In order to be able to identify the supply item 5, this may be provided with an identifier 9, as illustrated, for example a barcode or the like. In order to read the identifier 9 when it is inserted into the galley device 4, the identification device 8 may be designed as a barcode reader, for example as a CCD scanner or as a camera. In the example that is illustrated, the tray 5 has an identifier 9.

Provision may likewise be made for the products located on the trays 5 to be identified directly, for example likewise using barcodes or the like that are attached to the products. In alternative embodiments, the identification device 8 may additionally determine the external shape of the products and identify the products or the trays 5 on the basis thereof, for example by optically capturing the external shape, for example on the basis of object recognition algorithms based on object models of the products. The identification device 8 may be permanently integrated into the galley device 4. As an alternative, the identification device 8 may form a separate system.

In other implementations, the identification device 8 may furthermore, as an alternative or in addition, be designed to identify the supply item 5 in an interior 17 of the galley device 4. To this end, one or more sensors or cameras of the identification device 8 may be arranged in the interior 17 of the galley device 4. The control device 3 is designed to provide operating parameters for the identified supply item 5 and to operate the galley device 4 in accordance with the operating parameters. Such operating parameters may for example comprise: a preparation temperature and/or a preparation time (in the case of an oven or a microwave), a storage temperature and/or a storage time (for example for a cooling compartment), humidity, air pressure, air circulation, etc. The control device 3 may furthermore provide operating strategies and/or operating modes for the identified supply item 5, these defining a change in the operating parameters as a function of time.

The operation of the galley device 4, for example an oven, may thus be adapted automatically to the content of the supply item 5, for example a meal tray containing one or more ready meals 16, via the control device 3. By way of example, an oven temperature may be set automatically in an optimized manner for each meal. A preparation time, an airflow, an air pressure, a steam content in the galley device 4 or the like may also be regulated, for example. In the case of a refrigerator, for example, the cooling temperature may be regulated in order for example to prevent the products from freezing.

The optimum operating parameters and operating strategies for the preparation of meals may be stored in the data memory 10 so that they are able to be accessed during the process. These data, together with additional information about the identified supply item 5, may furthermore be displayed on the galley display 12. It may potentially also be possible, or necessary under certain circumstances, for the flight crew to adapt the data.

The system 1 is able to be optimized for different application cases, such as for example optimized meal quality, optimized availability of meals depending on the crew task or optimized energy consumption (with comprehensive energy management). The identification devices 8 may be part of the galley device 4 or be provided as an additional solution.

The system 1 thus allows, as it were, automatic self-adjustment of the galley devices 4 in accordance with the specification of the respective supply items 5. The identification process and the subsequent regulation may run fully automatically. By way of example, the system may be initialized automatically by opening a door 11 of a galley device 4, with an inserted supply item 5 then being automatically identified. As an alternative, of course, provision may likewise be made for manual initialization. The process may be monitored and, after it has ended, the process information may be stored for further optimization.

Some of the main advantages of the described inventory management for on-board catering may be summarized as follows:
It is ensured, at all times, that meals are prepared in an optimum and efficient manner.
It is likewise ensured that supply items are stored appropriately.
At the same time, the on-board personnel are unburdened and mistakes are avoided.
Organization, efficiency and clarity of the galley are optimized.

In order to improve the stringency of the representation, various features were combined in one or more examples in the detailed description above. However, it should be clear in this case that the description above is only of an illustrative and in no way restrictive nature. It is used to cover all alternatives, modifications and equivalents of the various features and exemplary embodiments. Many other examples will be immediately and directly clear to those skilled in the art on the basis of their technical knowledge in view of the description above.

The exemplary embodiments were chosen and described in order to be able to represent the principles on which the invention is based and their possible uses in practice in the best possible manner. As a result, experts may optimally modify and use the invention and its various exemplary embodiments for the intended purpose. In the claims and the description, the terms “containing” and “having” are used as neutral concepts for the corresponding term “comprising”. Furthermore, use of the terms “a”, “an” and “one” is not intended to fundamentally exclude a plurality of features and components described in such a way.

### LIST OF REFERENCE SIGNS

1 System
2 Galley
3 Control device
4 Galley device
5 Supply item
6 Service unit
7 Vehicle cabin
8 Identification device
9 Identifier
10 Data memory
11 Door
12 Galley display
13 Cabin management system
14 Galley monument
15 Slide-in compartment
16 Ready meal
17 Interior
18, 18′ Wireless data connection
19 Airline
20 Caterer
100 Aircraft

1. A system for automatically adapting operating parameters of a galley device on the basis of provided supply items for on-board catering for a vehicle, comprising:
a galley device having an identification device configured to identify a supply item; and
a control device for controlling the galley device, wherein the control device is configured to provide operating parameters for the identified supply item and to operate the galley device in accordance with the operating parameters.

2. The system as claimed in claim 1, wherein the galley device comprises at least one of an oven, a microwave and a cooling device.

3. The system as claimed in claim 1, wherein the operating parameters are selected from the group consisting of preparation temperature, storage temperature, preparation time, storage time, humidity, air pressure and air circulation.

4. The system as claimed in claim 1, wherein the control device is configured to provide an operating strategy for the identified supply item that specifies a change in the operating parameters as a function of time, and to operate the galley device in accordance with the operating strategy.

5. The system as claimed in claim 1, wherein the identification device is configured to identify the supply item on the basis of an identifier attached thereto.

6. The system as claimed in claim 1, wherein the identification device has a barcode reader.

7. The system as claimed in claim 1, wherein the identification device is configured to identify the supply item using object recognition.

8. The system as claimed in claim 1, wherein the identification device has a camera.

9. The system as claimed in claim 1, wherein the identification device is configured to identify the supply item in the region of a door and/or an access opening of the galley device.

10. The system as claimed in claim 1, wherein the identification device is configured to identify the supply item in an interior of the galley device.

11. The system as claimed claim 1, further comprising:
a data memory in communication with the control device, wherein the data memory is configured to store the operating parameters for specified supply items.

12. The system as claimed in claim 1, wherein the control device in communication with a cabin management system and/or a communication system of the vehicle.

13. The system as claimed in claim 1, further comprising:
a galley display configured to display the operating parameters and/or information about the identified supply item.

14. An aircraft comprising a system as claimed in claim 1.
